(19) United States
(12) Patent Application Publication
(10) Pub. No.: US 2004/0130132 A1
(43) Pub. Date: Jul. 8, 2004

(54) Integrated passenger airbag canister into seamless soft instrument panel

(76) Inventors: Jeffrey L Soncrant, Sterling Heights, MI (US); Richard A Hager, Commerce Twp, MI (US)

Correspondence Address: Robin W Asher, Clark Hill, 500 Woodward Avenu, Suite 3500, Detroit, MI, 48266-3435, US

(21) Appl. No.: 10/469,822

(22) PCT Filed: Mar. 6, 2002
(86) PCT No.: PCT/US02/06961

(51) Int. Cl. B60R 21/16

(52) U.S. Cl. 280/732

(57) ABSTRACT

An instrument panel assembly for an automotive vehicle comprising an instrument panel substrate having an upper wall spaced from a lower wall to define a cavity therebetween. The substrate includes an airbag housing secured in the cavity and having opposing sides extending from a closed end adjacent the lower wall and an open end adjacent the upper wall. An airbag module is provided including an inflatable bag and an inflator for inflating the bag. The airbag module is housed within the airbag housing between the closed end and the open end. An airbag covering having a first end affixed to one of the sides of the airbag housing and a second end abutting the opposite side of the airbag housing covers the open end of the housing. An instrument panel covering is affixed to the upper wall and the airbag covering by a foam in place process for covering and concealing the substrate and the airbag module.

### FIELD OF THE INVENTION

This invention relates to an instrument panel and, more particularly, to an airbag module integrated into a substrate of a foam in place instrument panel.

### BACKGROUND OF INVENTION

Automotive vehicles commonly include airbag modules attached to the instrument panel within the vehicle for protecting a vehicle passenger during a sudden impact to the vehicle. The airbag module typically includes a canister for housing an inflatable bag and inflator assembly for inflating the bag from the canister. The instrument panel typically includes a substrate covered by a foam in place soft covering. The canister is independently affixed to the substrate of the instrument panel after the instrument panel is formed and assembled. The instrument panel must be formed with a cavity for receiving the canister and an opening for allowing the inflatable bag to exit therethrough. The canister must also be structurally affixed to the instrument panel and supported thereby. The assembly of the canister and airbag module to the instrument panel increases the complexity of assembly and the cost of the instrument panel due to the excessive structure required and associated with the airbag module.

Therefore, it is desirable to provide an instrument panel having the canister portion of the airbag module integrated into the substrate of the instrument panel such that the airbag module may be assembled to the substrate prior to the foam in place process of forming the covering over the substrate and airbag module.

### SUMMARY OF THE INVENTION

The disadvantages of the prior art may be overcome by forming a one piece instrument panel substrate with an integrated airbag housing for housing the airbag module therein. The airbag housing may be covered to allow a soft instrument panel covering to be foam in place affixed to the instrument panel substrate and cover the airbag module.

According to one aspect of the invention, there is provided an instrument panel assembly for an automotive vehicle comprising an instrument panel substrate having an upper wall spaced from a lower wall to define a cavity therebetween. The substrate includes an airbag housing secured in the cavity and having opposing sides extending from a closed end adjacent the lower wall and an open end adjacent the upper wall. An airbag module is provided including an inflatable bag and an inflator for inflating the bag. The airbag module is housed within the airbag housing between the closed end and the open end. An airbag covering is operatively coupled to the airbag housing to cover the open end of the airbag housing. An instrument panel covering is affixed to the upper wall and the airbag covering for covering and concealing the substrate and the airbag module.

### DESCRIPTION OF THE DRAWINGS

In drawings which illustrate embodiments of the present invention,

FIG. 1 is a sectional view of the instrument panel assembly and integrated airbag module.

### DESCRIPTION OF THE INVENTION

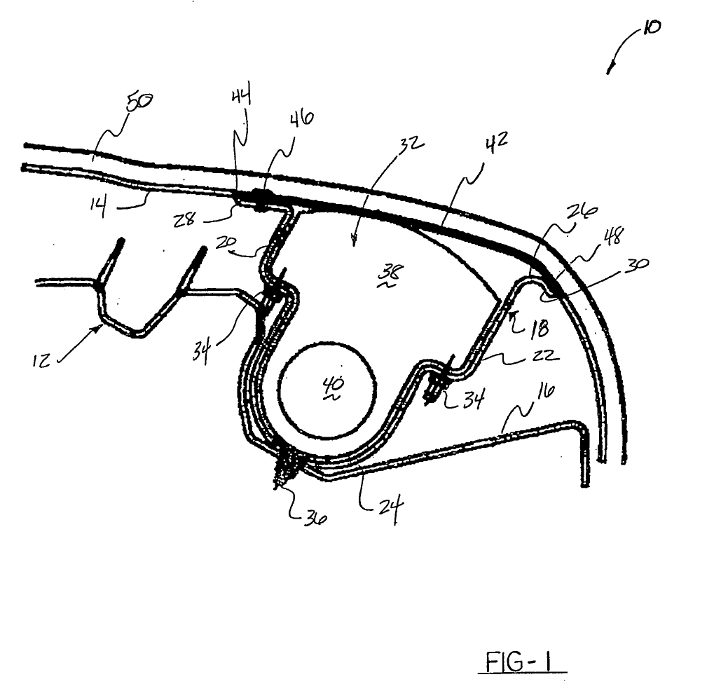

Referring to FIG. 1, an instrument panel assembly is generally shown at 10 for use in an automotive vehicle. The instrument panel assembly 10 includes a preformed, one piece, instrument panel substrate 12 which is typically molded of plastic and adapted to be fixedly secured within the interior compartment of the vehicle to form the dash/instrument panel of the vehicle. The substrate 12 includes an upper wall 14 and a lower wall 16 spaced from the upper wall 14 to form a cavity therebetween. A generally U-shaped airbag housing 18, defined by spaced apart opposing sides 20, 22, extends from a closed first end 24 adjacent the lower wall 16 to an open second end 26 adjacent the upper wall 14. The open end 26 is defined by flanges 28, 30 extending outwardly from the respective sides 20, 22 and attached to the upper wall 14 of the substrate 12. The airbag housing 18 may be integrally formed with the substrate 12 to form a one piece instrument panel substrate, or may be attached to one or both of the upper and lower walls 14, 16. The airbag housing 18 supports and houses a soft pack airbag module 32 therein. The airbag module 32 is fixedly secured to the housing 18 by a pair of side fasteners 34 and a lower fastener 36. The lower fastener 36 also extends through the lower wall 16 of the substrate 12 for securing the module 32, housing 18 and substrate 12 to the vehicle. The airbag module 32 includes an inflatable bag 38 and an inflator 40, as is commonly known to one having ordinary skill in the art.

The instrument panel assembly 10 further includes an airbag covering 42 operatively coupled to the airbag housing 18 to cover the open end 26 of the housing 18. More specifically, the covering 42 is a generally planar panel extending between the sides 20, 22 of the housing 18 to cover the open end 26. A first end 44 of the covering 42 is fixedly attached to the flange 28 of the housing 18 by a fastener 46, while an opposite second end 48 abuts the flange 30, but is free from attachment to the housing 18. The assembly 10 also includes an instrument panel covering 50 attached to the upper wall 14 of the substrate 12 for covering the substrate and airbag module 32. The instrument panel covering 50 may be a urethane foam layer having a soft, cosmetic, textile outer surface or trim cover wrapping, as is commonly known in the art. The instrument panel covering 50 is attached to the substrate 12 by a foam in place process, thermoforming operation, or other conventional manufacturing method.

In assembly, the substrate 12 is preformed by molding, injecting, or the like, the upper and lower walls 14, 16 and the airbag housing 18. The airbag module 32 is then assembled in the airbag housing 18 and secured thereto by the fasteners 34, 36. The airbag covering 42 is attached to the housing 18 by the fastener 46 to cover the open end 26 and the airbag module 32. The covering 42 protects the airbag module 32 during the foam in place process and provides a door for allowing the inflatable bag 38 to expand therethrough. Once the covering 42 is attached to the substrate 12 to cover and protect the airbag module 32, the substrate 12 and covering 42 are covered by the instrument panel covering 50 via the foam in place process. This assembly forms an integrated airbag module into a seamless soft instrument panel while eliminating an independent canister to house the airbag module within the instrument panel substrate. That is, the housing 18 for the airbag module 32 is integrated into the substrate 12 and then covered by the airbag covering 42 to allow foaming of the soft instrument panel covering 50.

The above-described embodiment of the invention is intended to be an example of the present invention and alterations and modifications may be effected thereto, by those of skill in the art, without departing from the scope of the invention.

What is claimed is:

1. An instrument panel assembly for an automotive vehicle comprising:
an instrument panel substrate having an upper wall spaced from a lower wall to define a cavity therebetween, said substrate including an airbag housing secured in said cavity and having opposing sides extending from a closed end adjacent said lower wall and an open end adjacent said upper wall;
an airbag module including an inflatable bag and an inflator for inflating said bag, said airbag module housed within said airbag housing between said closed end and said open end;
an airbag covering operatively coupled to said airbag housing to cover said open end of said airbag housing; and
an instrument panel covering affixed to said upper wall and said airbag covering
for covering and concealing said substrate and said airbag module.

2. An instrument panel assembly as set forth in claim 1 wherein said airbag housing is integrally formed with said instrument panel substrate.

3. An instrument panel assembly as set forth in claim 2 wherein said open end of said airbag housing is defined by flanges extending outwardly from said respective sides and attached to said upper wall of said instrument panel substrate.

4. An instrument panel as set forth in claim 3 wherein said instrument panel covering is formed over said instrument panel substrate and said airbag covering by a foam in place process.

5. An instrument panel assembly as set forth in claim 4 wherein said airbag covering extends between a first end affixed to one of said sides of said airbag housing and a second end abutting said opposite side of said airbag housing for covering said open end of said airbag housing, allowing said inflatable bag to expand therethrough, and for protecting said airbag module during formation of said instrument panel covering in said foam in place process.

6. An instrument panel assembly as set forth in claim 5 wherein said airbag covering is generally planar between said first and second ends for covering said open end of said airbag housing.

7. An instrument panel assembly as set forth in claim 6 wherein said upper and lower walls are spaced apart and generally parallel to define the cavity therebetween.

8. An instrument panel assembly as set forth in claim 7 wherein said sides of said airbag housing are spaced apart and generally parallel for receiving said airbag module therebetween.

9. An instrument panel assembly as set forth in claim 8 wherein said sides of said airbag housing are generally perpendicular to said upper wall.
